(19) United States
(12) Patent Application Publication
(10) Pub. No.: US 2023/0012874 A1
(43) Pub. Date: Jan. 19, 2023

(54) MIKVAH SANITATION DEVICES

(71) Applicant: POOL PURITY LTD, JERUSALEM (IL)

(72) Inventors: Jonathan Jacob HELLER, JERUSALEM (IL); Tomer Jay LEVY, BET SHEMESH (IL); Yishai SHMUEL Retyk, Beit Meir (IL)

(21) Appl. No.: 17/864,443

(22) Filed: Jul. 14, 2022

(30) Foreign Application Priority Data
Jul. 14, 2021 (IL) 284869

(51) Int. Cl. C02F 1/00; C02F 1/32; B01D 29/11; B01D 35/30

(52) U.S. Cl. CPC C02F 1/001; C02F 1/325; B01D 29/114; B01D 35/30; C02F 2201/006; C02F 2201/328; C02F 2303/04; C02F 2201/002; C02F 2103/42

(57) ABSTRACT

A sanitation device for cleaning a body of water in an immersion pool of a mikvah has a housing, a driving member and a bypass passageway. The housing includes an inlet, an outlet and internal liquid passages that communicate between the inlet and outlet. The driving member is arranged to urge flow of liquid through the internal liquid passages by exerting thrust upon liquid flowing through the driving member, wherein at least part of the liquid flowing through the liquid passages bypasses flowing through the driving member by flowing through the bypass passageway towards the device's outlet.

### TECHNICAL FIELD

Embodiments of the invention relate to mikvah sanitation devices, in particular for improving sanitation conditions in a body of water of a mikvah in which believers bathe to achieve ritual purity.

### BACKGROUND

Classical rabbinical literature dictates many rules relating to the construction of a mikvah (or mikveh). For example, a mikvah has to be connected to a source of naturally occurring water, it must contain sufficient water to cover the entire body of an average-sized person; and the required volume of water should be about 40 seah.

Additional requirements dictate the manner in which the water can be stored and transported to or within the mikvah. For example it is forbidden for the water to pass through any vessel which could hold water within it. If however a vessel has an ‘opening’ that is large enough to fulfill a criteria called ‘mouthpiece of a drinking pouch’ (shfoferes hanod)—then the vessel may be used for filling or channeling water in a mikvah.

The booklet “Understanding Mikvah: An Overview of Mikvah Construction” by the author ‘Rabbi Schneur Zaiman Lesches’; ISBN 0-9689146-0-8 (2001); specifies many of the requirement relating to a Mikvah. It specifies, inter alia, at pages 43 and in particular 44 and footnotes 67, 72 and 73 that an ‘opening’ in a vessel that qualifies as a ‘mouthpiece of a drinking pouch’ should be large enough for two average fingers to fit in and rotate.

The booklet further details that the dimension of such an ‘opening’ equals to a quarter of a tefach (the common measure for one tefach as used in modern mikvah's is 10 centimeters); and thus according to this measurement such an ‘opening’ could be as small as about 25 millimeters in width (see footnotes 67 and 72). In an enhancement (hiddur) that goes beyond the formal demands of rabbinical law—an ‘opening’ qualifying as a ‘mouthpiece of a drinking pouch’ should be at least 48 millimeters in width (see footnote 73).

Rabbinical rules relating to the purity and hence cleanliness and sanitation of the body of water in a mikvah are strictly followed, and thus to avoid unfit water, the water in a mikvah can often be completely drained away and refilled from scratch resulting in large quantities of water that are wasted. In cases where water in the Mikvah is heated, re-filling a Mikvah with new water requires re-heating the water, a process that is wasteful in energy. Thus, being able to use the water in the mikvah for longer periods of time, while maintaining water cleanliness and the required purity of the water for its intended religious ritual, is advantageous.

### SUMMARY

The following embodiments and aspects thereof are described and illustrated in conjunction with systems, tools and methods which are meant to be exemplary and illustrative, not limiting in scope.

In an embodiment of the present invention there is provided a sanitation device for cleaning a body of water in an immersion pool of a mikvah, the sanitation device comprising a housing, a driving member and a bypass passageway, the housing defining an inlet, an outlet and internal liquid passages that communicate between the inlet and outlet, the driving member being arranged to urge flow of liquid through the internal liquid passages by exerting thrust upon liquid flowing through the driving member, wherein at least part of the liquid flowing through the liquid passages bypasses flowing through the driving member by flowing through the bypass passageway towards the device's outlet.

In an embodiment, a cross sectional extension, e.g. diameter, of the bypass passageway is sized to fulfill a criteria of ‘mouthpiece of a drinking pouch’ (shfoferes hanod) by being generally equal to or greater than about 25 millimeters, and in an enhancement (hiddur) preferably generally equal to or greater than about 48 millimeters.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows an embodiment of a sanitation device suitable for being located in the water of a mikvah;

FIG. 2 schematically shows a cross sectional view of the sanitation device;

FIG. 3 schematically shows a partial cross sectional view of a lower portion of the sanitation device; and

FIGS. 4A, 4B and 5 schematically show an additional embodiment of a sanitation device suitable for being located in the water of a mikvah.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

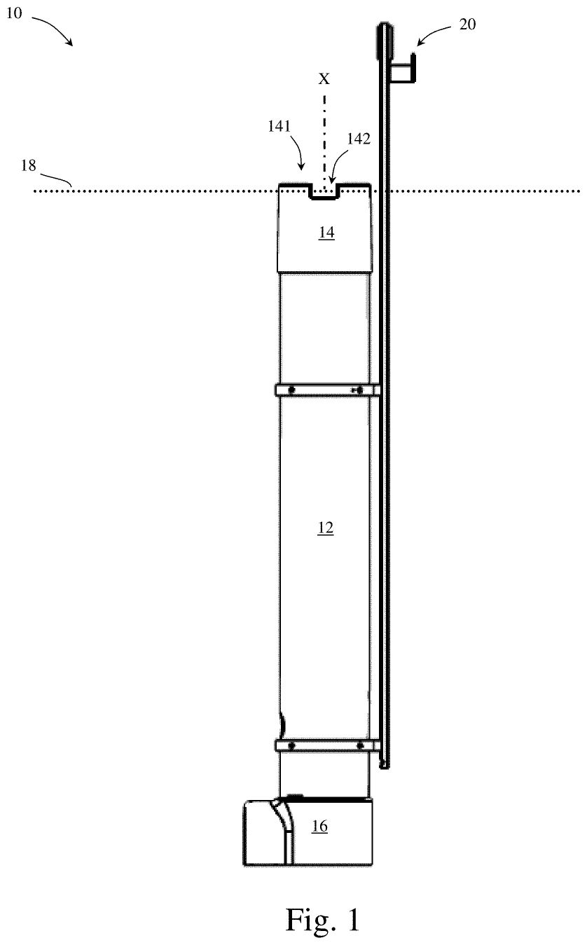

Attention is drawn to FIG. 1 illustrating an embodiment of a sanitation device 10 here in possible form of a filter. Device 10 includes a generally cylindrical middle housing section 12 that is formed about an axis X, a top float section 14 that is axially slidable with respect to the middle pipe, and a bottom housing section 16 that is here optionally angled by about 90 degrees with respect to the middle section and its axis X.

Top float 14 is arranged to have a buoyancy that maintains its upper edge 141 just above and/or generally flush with the upper surface 18 of the water. Upper edge may have recess bays 142 formed therein to provide passageways for water to flow passed the upper edge and into the device.

Sanitation device 10 in this example may be fixed via a fixture 20 to a side wall of the mikvah's immersion pool or to any other support available adjacent the immersion pool—and by that may be maintained fix in place within the water of the mikvah. Such fixing of the device may be in a removable manner to allow easy removal of the filter from the mikvah.

In order to compensate for relative slight changes (e.g. of up to about 25 centimeters) in the level of water in the mikvah—top float 14 may be arranged to slide with respect to middle housing section 12. Therefore, if the water rises slightly (e.g. due to a bather entering the water) top float 14 can slide upwards in relation to middle housing section 12 to maintain upper edge 141 suitably located just above and/or generally flush with the upper surface of the water.

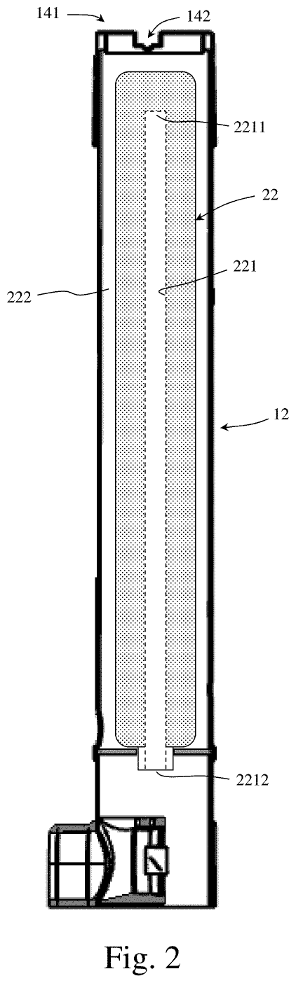

Attention is drawn to the cross sectional view of FIG. 2 revealing a filter cartridge 22 located within and in this example substantially along at least a portion of the middle housing section of the device. Filter cartridge 22 includes an interior hollow axially extending passage 221 that is closed at its upper upstream end 2211 and opens out of the cartridge at a passage outlet that is located at its lower downstream end 2212. An axially extending peripheral gap 222 is formed about the filter cartridge between an outer periphery of the cartridge and an inner peripheral face of middle housing section 12.

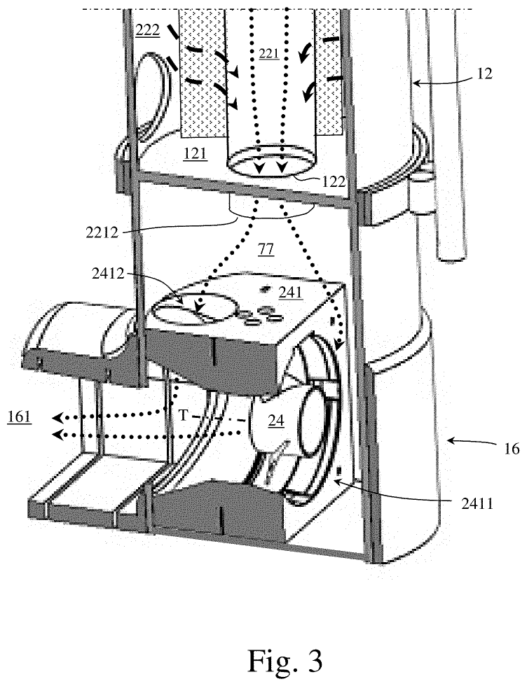

Attention is additionally drawn to the cross sectional view of FIG. 3 revealing a lower portion of middle housing section 12 and an interior of the bottom housing section 16. A plate 121 having an opening 122 is located at a lower side of the middle section's interior. As seen, a lower side of filter cartridge 22 reaches up to adjacent plate 121 with an extension of its passage 221 passing through opening 122 to locate the passage's outlet at downstream end 2212 at a position where it opens into a cavity 77 formed immediately downstream to the plate.

Within the bottom housing section 16, the sanitation device includes a motorized propeller 24. Propeller 24 is housed within section 16 in a housing block 241 that includes a first passageway 2411 and second bypass passageway 2412. First passageway 2411 generally surrounds the propeller 24 and second bypass passageway 2412 communicates between cavity 77 and a location within bottom housing section 16 that is downstream to the propeller. Therefore, bypass passageway 2412 serves as a route for water flowing through the filter to bypass flowing directly through the propeller.

The propeller when powered to revolve is arranged to urge a downstream directed flow of water, which in this example exits the sanitation device back into the main body of water of the mikvah via an outlet 161 formed in the bottom housing section 16.

The downstream flow of water formed by the propeller is arranged to draw water from the upper surface of the body of water of the mikvah into the device via top float 14. The water entering the device at its upstream side fills the peripheral gap 222 formed about the filter cartridge and then flows passed filter cartridge 22 into its passage 221 as illustrated by the ‘dashed’ arrows in FIG. 3.

As seen by the ‘dotted’ arrows in FIG. 3, the water arriving and flowing through passage 221 reaches cavity 77, where it forks in this example into two main parts. A first part that is drawn to flow from cavity 77 via first passageway 2411 and through the propeller 24 on its route to exit the device via outlet 161, and a second part that is drawn to flow from cavity 77 via bypass passageway 2412 on its route to exit the device via outlet 161. The water flowing through bypass passageway 2412 thus bypasses flowing directly through the propeller on route to exit the device via outlet 161 into the main body of water of the mikvah.

In at least certain sanitation device embodiments, bypass passageway 2412 may be sized to define a route towards the device's outlet 161 that has a cross sectional extension (e.g. diameter) of at least about 25 millimeters (or more); and in an enhancement (hiddur) at least about 48 millimeters (or more)—in order to provide an ‘opening’ between the main body of water of the mikvah and the water passages upstream of housing block 241, namely cavity 77 and passage 221—that fulfills the criteria of ‘mouthpiece of a drinking pouch’ (shfoferes hanod).

By maintaining a cross sectional extension (e.g. diameter) of water passages downstream to bypass passageway 2412 on route to outlet 161 and also upstream to bypass passageway 2412 (in particular passage 221)— of at least about 25 millimeters (or more); and in an enhancement (hiddur) at least about 48 millimeters (or more)—a full extension of the water passages from passage 221 to outlet 161 is available for fulfilling the criteria of ‘mouthpiece of a drinking pouch’ (shfoferes hanod).

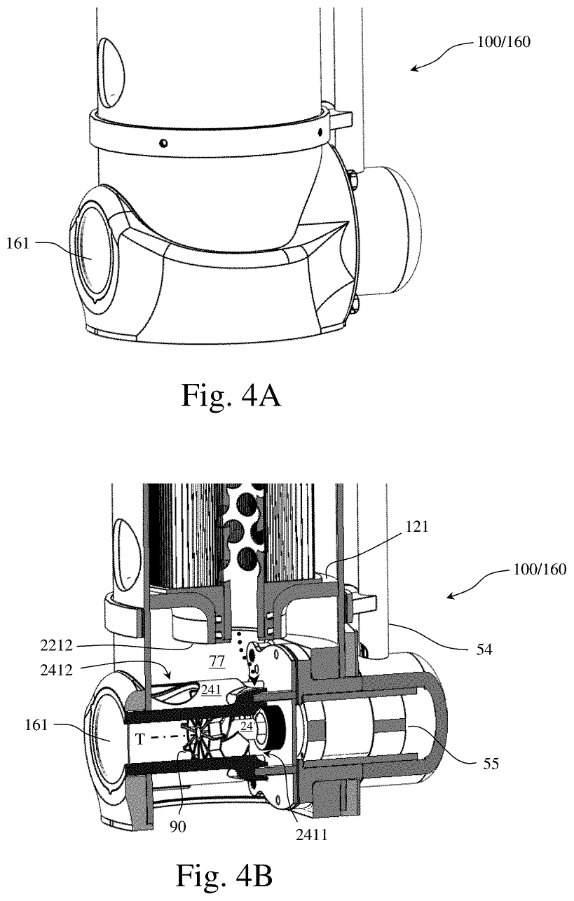

Attention is drawn to FIGS. 4A and 4B showing a bottom housing section 160 of an embodiment of a sanitation device 100 of the present invention, where FIG. 4B is a cross sectional view of FIG. 4A.

Similar to the embodiment in FIG. 3, sanitation device 100 includes a motorized propeller 24 that is arranged to rotate about a rotational axis T, and is housed within a housing block 241, which includes a first passageway 2411 and second bypass passageway 2412. First passageway 2411 generally surrounds the propeller 24 and second bypass passageway 2412 communicates between cavity 77 and a location within bottom housing section 160 that is downstream to the propeller, such as outlet 161.

In at least certain sanitation device embodiments, bypass passageway 2412 may be sized to define a route towards the device's outlet 161 that has a cross sectional extension (e.g. diameter) of at least about 25 millimeters (or more); and in an enhancement (hiddur) at least about 48 millimeters (or more)—in order to provide an ‘opening’ between the main body of water of the mikvah and the water passages upstream of housing block 241, namely cavity 77 and passage 221—that fulfills the criteria of ‘mouthpiece of a drinking pouch’ (shfoferes hanod).

Bypass passageway 2412 with respect to the embodiment seen in FIG. 3 was described as possibly serving as a route for at least part of the water flowing through the filter—to bypass flowing directly through the propeller. It is noted that such outcome of flow via bypass passageway 2412 in a downstream direction towards outlet 161 may be possible in certain situations. For example if, inter alia, the flow path 78 formed about axis T immediately downstream of the propeller were to be made in a venturi like formation (or the like).

During a cleaning operation of sanitation devices of the present disclosure (such as 10 and 100) and while propeller 24 is activated, the pressure at cavity 77 may be lower than at outlet 161 and therefore at least such pressure difference between outlet 161 and cavity 77 may not encourage such flow through bypass passageway 2412 in a downstream direction towards outlet 161.

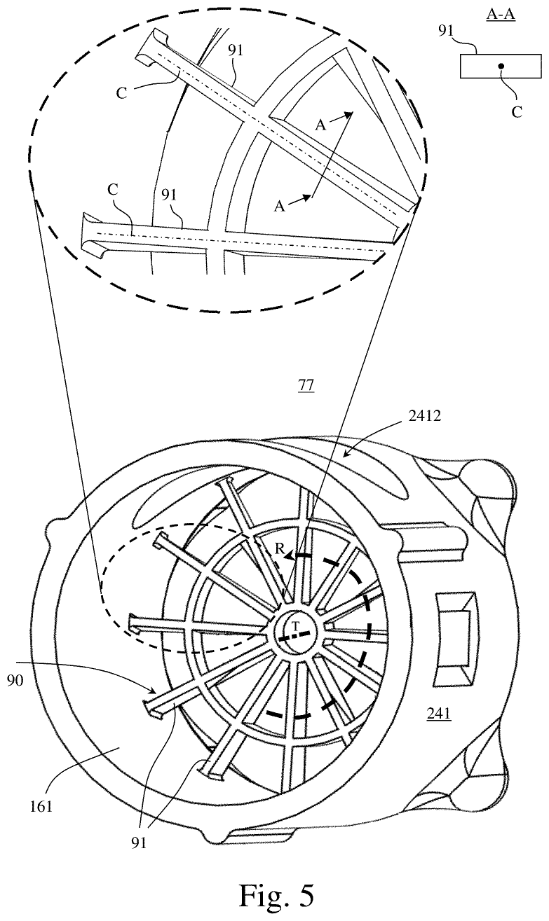

Attention is drawn to FIG. 5 showing an interior of housing block 241 when viewed via outlet 161. This view reveals a possible truss 90 that may be located at a downstream side of the propeller. Truss 90 in this example includes a plurality of vanes 91 that are symmetrically distributed about axis T and extend each radially outwards along a respective center axis C away from axis T.

During operation of the sanitation device (such as 10, 100), propeller 24 rotates about rotational axis T in a rotational direction R in order to urge water flow through the device and downstream back to the body of water of the mikvah via outlet 161. Due to the rotational motion of the propeller, the water urged downstream towards outlet 161 may assume a generally turbulent flow pattern.

In experiments performed by the inventors it was observed that in certain cases, the turbulence in the water flow may reduce the efficiency of the sanitation device by encouraging back flow of water via bypass passageway 2412 towards cavity 77, where low pressure in any case may be present as discussed.

In order to mitigate or substantially avoid such reduction of efficiency in a sanitation device of the present disclosure, the vanes 91 of the truss may be designed to reduce the turbulence of the water.

In one example, the vanes may each be twisted about their respective axes C to assume a formation that counters the rotational turbulence formed by the propeller—so that the resulting water flow downstream towards the outlet may be more laminar. Increasing the speed of water flow may be another measure for mitigating the discussed loss of efficiency of the sanitation device.

As seen in FIGS. 4A and 4B, a motor 55 powering the propeller may be located adjacent the propeller submerged in the water of the mikvah, and may be provided with electrical power via a power line 54.

In certain embodiments, UV light sources (possibly LED UV light sources) may be positioned adjacent the propeller and/or in a vicinity of cavity 77 in order to act as a radiation disinfectant to the water flowing through the sanitation device. Optionally, electrical power provided to the motor may also be used in some cases to power such UV light sources.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Further more, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A sanitation device for cleaning a body of water in an immersion pool of a mikvah,
the sanitation device comprising an outer housing and a filter cartridge and a housing block that are located within the outer housing,
the housing block comprising a first passageway and a second bypass passageway that are formed therethrough as distinctly different and separated passageways, wherein the sanitation device further comprises a driving member that is located within the first passageway,
the outer housing defining an inlet, an outlet and internal liquid passages that communicate between the inlet and outlet, and
the driving member being arranged to urge flow of liquid through the internal liquid passages by exerting thrust upon liquid flowing through the driving member, wherein
at least part of the liquid flowing through the liquid passages flows through the filter cartridge to reach a cavity within the outer housing and flow onwards through the first passageway and driving member towards the device's outlet, and wherein
liquid within the cavity is also in liquid communication with liquid at the device's outlet via the bypass passageway.

2. The sanitation device of claim 1, wherein the driving member comprises a propeller for exerting the thrust.

3. The sanitation device of claim 2, wherein a cross sectional extension, e.g. diameter, of the bypass passageway is generally equal to or greater than about 25 millimeters, and preferably generally equal to or greater than about 48 millimeters.

4. The sanitation device of claim 3, wherein all liquid passages located downstream to the bypass passageway on route to the outlet are also generally equal to or greater than about 25 millimeters, and preferably generally equal to or greater than about 48 millimeters.

5. The sanitation device of claim 4, wherein at least some of the liquid passages located upstream to the bypass passageway are also generally equal to or greater than about 25 millimeters, and preferably generally equal to or greater than about 48 millimeters.

6. The sanitation device of claim 1 and comprising a truss at a location immediately downstream to the driving member for assisting in reducing turbulence in liquid urged downstream towards the outlet by the driving member.

7. The sanitation device of claim 1 and comprising UV light sources adjacent the driving member and/or in a vicinity of the cavity in order to act as a radiation disinfectant to liquid flowing through the sanitation device.

8. A sanitation device for cleaning a body of water in an immersion pool of a mikvah,
the sanitation device comprising an outer housing and a filter cartridge and a motorized propeller located within the outer housing,
the outer housing having an inlet and an outlet, and the motorized propeller being arranged to exert thrust upon liquid flowing through the propeller in order to draw liquid from the immersion pool's body of water into the housing via the inlet and back out through the outlet to the immersion pool's body of water,
the liquid being urged to flow through the outer housing between the inlet and outlet passes via the filter cartridge before reaching a cavity at a vicinity of the motorized propeller to then flow onwards downstream through the propeller towards the outlet of the sanitation device, wherein
the sanitation device comprises in addition a distinct and separate bypass passageway located within the outer housing through which liquid in the cavity is in liquid communication with liquid at the outlet of the sanitation device.

9. The sanitation device of claim 8, wherein the bypass passageway is located adjacent to the motorized propeller.

10. The sanitation device of claim 9, wherein a cross sectional extension, e.g. diameter, of the bypass passageway is generally equal to or greater than about 25 millimeters, and preferably generally equal to or greater than about 48 millimeters.

11. The sanitation device of claim 10, wherein all liquid passages located downstream to the bypass passageway on route to the outlet are also generally equal to or greater than about 25 millimeters, and preferably generally equal to or greater than about 48 millimeters.

12. The sanitation device of claim 10, wherein at least some of the liquid passages located upstream to the bypass passageway are also generally equal to or greater than about 25 millimeters, and preferably generally equal to or greater than about 48 millimeters.

13. The sanitation device of claim 12, wherein the at least some of the liquid passages are the liquid passages leading liquid exiting the filter cartridge towards the bypass passageway.

14. The sanitation device of claim 8, wherein the outer housing extends upright within the immersion pool with its inlet being located generally flush with the upper surface of the immersion pool and the outlet being located closer, possibly adjacent, to the floor of the immersion pool.

15. The sanitation device of claim 8 and comprising UV light sources adjacent the motorized propeller and/or in a vicinity of the cavity in order to act as a radiation disinfectant to liquid flowing through the sanitation device.

16. A method for cleaning a body of water in an immersion pool of a mikvah, and comprising the steps of:
providing a sanitation device comprising an outer housing, a filter cartridge, a driving member and a bypass passageway, the outer housing defining an inlet, an outlet and internal liquid passages that communicate between the inlet and outlet,
powering the driving member to urge flow of liquid through the internal liquid passages of the housing and via the filter cartridge by exerting thrust upon liquid flowing through the driving member, wherein
liquid flowing through the filter cartridge reaches a cavity within the outer housing and then flows past the driving member towards the outlet of the sanitation device, wherein
liquid in the cavity is also in liquid communication with liquid at the outlet of the sanitation device via the bypass passageway that is a distinct and separate passageway that does not house the driving member.

17. The method of claim 16, wherein the driving member comprises a propeller for exerting the thrust.

18. The method of claim 17, wherein a cross sectional extension, e.g. diameter, of the bypass passageway is generally equal to or greater than about 25 millimeters, and preferably generally equal to or greater than about 48 millimeters.

19. The method of claim 18, wherein all liquid passages located downstream to the bypass passageway on route to the outlet are also generally equal to or greater than about 25 millimeters, and preferably generally equal to or greater than about 48 millimeters.

20. The method of claim 19, wherein at least some of the liquid passages located upstream to the bypass passageway are also generally equal to or greater than about 25 millimeters, and preferably generally equal to or greater than about 48 millimeters.
